(19) United States
(12) Patent Application Publication
(10) Pub. No.: US 2009/0005518 A1
(43) Pub. Date: Jan. 1, 2009

(54) Block Condensates of Organofunctional Siloxanes, Their Preparation and Use, and Their Properties

(75) Inventors: Eckhard Just, Rheinfelden (DE); Sabine Giessler-Blank, Rheinfelden (DE); Burkhard Standke, Lorrach (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Degussa Gmbh, Deusseldorf (DE)

(21) Appl. No.: 11/572,555

(22) PCT Filed: Jun. 3, 2005
(86) PCT No.: PCT/EP05/52559

§ 371 Date: Jan. 23, 2007

(30) Foreign Application Priority Data
Jul. 29, 2004 (DE) 10 2004 037 043.5

(51) Int. Cl. C09D 183/04; B05D 3/10

(52) U.S. Cl. 525/474; 427/387

(57) ABSTRACT

The present invention relates to a composition which comprises (i) at least one block condensate of organofunctional siloxanes of the general formula (I) [F]e[QcPb]d (I) and/or (ii) at least one mixture composed of e[F] and d(c[Q]+b[P]) and, where appropriate d[QcPb]. These compositions or block condensates are obtainable via reaction of block units F with block units Q, P, and/or QP, by one of the following methods:—c1) diluting block unit F optionally with an alcohol, adding an organic or inorganic acid and from 0.5 to 150 mol of water per mole of Si of the siloxane used, whereupon at least partial hydrolysis of the block units used takes place, then adding block unit Q and block unit P, and allowing the mixture to react, or—c2) diluting block unit F optionally with an alcohol, mixing with Q, P, and/or block unit QP, then adding an organic or inorganic acid and, using from 0.5 to 150 mol of water per mole of Si of the siloxanes used, carrying out partial hydrolysis and block-condensation, or—c3) diluting block unit F optionally with an alcohol, adding an organic or inorganic acid and from 0.5 to 150 mol of water per mole of Si of the siloxane used, with at least partial hydrolysis, adding block unit QP, and allowing the mixture to react, or—c4) diluting block units Q, P, and/or QP, optionally with an alcohol, adding an organic or inorganic acid and from 0.5 to 1.5 mol of water per mole of Si of the siloxanes used, and at least partially hydrolyzing, then adding block unit F and also from 0 to 148.5 mol of water per mole of Si of the siloxanes used, and allowing the mixture to react, or—c5) diluting block unit F optionally with an alcohol, mixing with from 0.5 to 150 mol of water per mole of Si of the siloxanes used, and with an organic or inorganic acid, and then adding a tetraalkoxysiloxane, and allowing the mixture to react. The present invention further relates to a process for the preparation of these compositions or block condensates, and to their use and to items thus obtainable: abrasion-resistant easy-clean coatings and items equipped with this type of coating.

The present invention relates to fluoro-organofunctional siloxanes, to compositions which comprise these fluoro-organosiloxanes, to a process for the preparation of these organosilicon compounds, and also to their use.

“Easy-clean” is the everyday term used for surface properties that substantially repel oil, water, and soiling.

Easy-clean coatings which are based on hydrolyzable and condensable fluoroorganosilanes and which have properties that repel oil, water, and soiling have long been known (inter alia DE 834 002, DE 15 18 551, DE 195 44 763).

Among the existing coating systems, those based on fluoro-organofunctional silanes and, respectively, siloxanes are the most suitable in terms of easy-clean properties. Materials that have been described for the production of an easy-clean coating are appropriate undiluted systems, solvent-containing systems, emulsions, and also aqueous systems (inter alia WO 92/21729, WO 95/23830).

The general method of preparing water- or alcohol-containing coating systems has been to combine the starting materials, such as hydrolyzable fluoroalkyl-, amino-, and optionally alkylsilanes, and solvent, water, and catalyst, and to carry out hydrolysis and condensation. A possible method here begins by pre-hydrolyzing the silanes that are not fluoro-organofunctional, for example the aminoalkoxysilane, the fluorosilane component then being added and condensed onto the material (WO 92/21729).

However, another possible method pre-hydrolyzes the water-insoluble silane component, i.e. the fluorosilane and optionally the alkylalkoxysilane, and then condenses the water-soluble aminosilane onto the material (EP 0 738 771 A).

Yet another possible method hydrolyzes and cocondenses said organoalkoxysilane components in the presence of a catalyst (EP 0 846 717 A, EP 0 846 716 A, EP1 101 787 A).

EP 0 960 921 A discloses a process for the preparation of oligomeric organopolysilane cocondensates, where cocondensates were produced from at least two hydrolyzable organoalkoxysilanes, and then the particles were enlarged via oligomerization.

Another possible process which has also been very generally proposed is block polymerization or partial block copolymerization, the resulting systems being used for the preparation of emulsions (WO 95/23830).

However, the easy-clean coatings known hitherto have low abrasion resistance.

It was therefore an object of the present invention to provide an easy-clean system which after application has better bonding and abrasion resistance of the coating.

The invention achieves the object through the features of the patent claims.

Surprisingly, it has been found that an improvement in the bonding to a substrate surface, or an improvement in the abrasion resistance of easy-clean coatings based on fluoroorganosiloxanes can be achieved if use is made of an active ingredient that is based on block condensates containing fluoro-organofunctional siloxane, or on block condensates based on a mixture composed of fluoroorganosiloxane and of organosiloxane, this being a preparation process in which at least one block unit or at least one block condensate is based on a proportion of tetraalkoxysilane. Here and hereinafter, a block unit means an organosiloxane or an oligomeric mixture of the relevant organosiloxane. Here and hereinafter, block condensates are condensation products derived from at least two block units with different functionality.

Surprisingly, the proportion of tetraalkoxysilane can achieve not only greater control in the linkage of the siloxane units to one another but also to any other additives present, and moreover good bonding to a substrate surface on application. The present coating, based on this inventive system, therefore features not only—to use abbreviated terminology—easy-clean properties and better abrasion resistance but also excellent chemicals resistance, in particular with respect to solvents, alkaline solutions, acids, and various cleaning compositions, such as household cleaners.

It has also been found that the resistance of said coatings to boiling water can be improved via the teaching of the invention, this being particularly advantageous for ceramic coatings. A further long-lasting improvement in applications for anti-graffiti purposes, in particular on concrete, could also be obtained via these properties of the novel coating system.

The novel coating systems also feature excellent application properties, and in particular excellent crosslinking within the coating and to the substrate surface, even at room temperature.

The inventive coating systems can moreover be used advantageously for corrosion-protection applications.

The present invention therefore provides a composition which comprises
(i) at least one block condensate of organofunctional siloxanes of the general formula I

[F]ₑ[Q_{c}P_{b}]_{d} (I)
and/or
(ii) optionally, a mixture composed of e[F] and d(c[Q]+b[P]) and, where appropriate d[Q_{c}P_{b}],
where in each case independently of one another in the above-mentioned features (i) and (ii)
the block units F, Q, P and/or QP may have linkage to one another by way of at least one Si—O—Si bond,
e, c and d are identical or different, and each may be a number from 1 to 10, preferably from 1 to 5 and b may be a number from 0 to 10, preferably from 0 to 5, and in particular c≧b,
F is a linear, cyclic, branched, or crosslinked cocondensate unit, i.e. block unit F, from the series of fluororgano-/aminoalkyl-/alkyl-/alkoxy- or hydroxysiloxanes of the general formula II

R[—O—Si(OR)₂]_{w}[—O—Si(R^{f})(R¹)₁₋ₕ(OR)ₕ]ₓ[—O—Si{R^{a}(HX)_{g}}(CH₃)₁₋ᵢ(OR)ᵢ]_{y}[—O—Si(R²)₂₋ⱼ(OR)ⱼ]_{z}(OR) (II),
where R^{f} is a mono-, oligo- or polyfluorinated organoalkyl or organoaryl group of the formula (IIa) R³—Y_{#}—(CH₂)₂—, where R³ is a linear, cyclic, or branched mono-, oligo-, or polyfluorinated alkyl group having from 1 to 13 carbon atoms or a mono-, oligo-, or polyfluorinated aryl group, Y is a CH₂, O, or S group, where #=0 or 1,
R^{a} is an aminoalkyl group of the general formula (IIb) H₂N(CH₂)_{§}[(NH)_{$}(CH₂)_{&}]_{β}—, where 0≦§≦6, 0≦&≦6, $=0 if §=0 then β=1, $=1 if §>0 then β=1 or 2, and X is an acid radical from the series chloride, formate, and acetate where g=0 or 1 or 2 or 3,
h, l, and j, independently of one another, are 0 or 1,
groups R² are identical or different, and R² is a linear, cyclic, or branched alkyl group having from 1 to 18 carbon atoms,
R¹ is a linear, cyclic, or branched alkyl group having from 1 to 8 carbon atoms,
groups R are identical or different and are a hydrogen atom or a linear, cyclic, or branched alkyl group having from 1 to 4 carbon atoms, or RO is an —O—Si— bond to at least one unit from the series F, Q or P or QP,
x, y, z and w are identical or different, where x>0, y>0, z≧0, w≧0 and (x+y+z+w)≧2 and preferably x is a number from 1 to 10, y is a number from 1 to 40, in particular from 2 to 10, z is a number from 0 to 10, and w is a number from 0 to 10,
Q is an alkyl silicate unit, i.e. block unit Q, of the general formula III

(RO)ₙSiO_{(4-n)/2} (III),
where groups R are identical or different and are a hydrogen atom or a linear, cyclic, or branched alkyl group having from 1 to 4 carbon atoms, or RO are an —O—Si— bond to at least one unit from the series F, Q, P, or QP, and n=1 or 2 or 3, where the average degree of oligomerization in the units Q is preferably from 3 to 20, where the range of degree of oligomerization in the mixture is generally from 1 to 50,
and
P is a linear, cyclic, branched, or crosslinked condensate unit or, respectively, cocondensate unit, i.e. block unit P, of the general formula IV

R[—O—Si(R²)₂₋ᵥ(OR)ᵥ]ᵣ[—O—Si{R^{a}(HX)_{g}}(CH₃)₁₋ᵤ(OR)ᵤ]ₛ(OR) (IV),
where R^{a} is an aminoalkyl group of the general formula (IVa) H₂N(CH₂)_{§}[(NH)_{$}(CH₂)_{&}]_{β}—, where 0≦§≦6, 0≦&≦6, $=0 if §=0 then β=1, $=1 if §>0 then β=1 or 2, and X is an acid radical from the series chloride, formate, and acetate where g=0 or 1 or 2 or 3,
groups R² are identical or different, and R² is a linear, cyclic, or branched alkyl group having from 1 to 18 carbon atoms,
v=0 or 1 or 2, and u is 0 or 1,
groups R are identical or different and are a hydrogen atom or a linear, cyclic, or branched alkyl group having from 1 to 4 carbon atoms, or RO is an —O—Si— bond to at least one unit from the series F, Q or P,
r and s are identical or different, and r≧1, s≧0 and (r+s)≧1, and s is preferably a number from 0 to 30, and r is preferably a number from 2 to 20.

Inventive compositions generally feature a total organosiloxane content of from 0.001 to 99.9% by weight, where the proportion of block units F, based on the amount of organosiloxane in the composition, is preferably from 0.005 to 99% by weight, particularly preferably from 0.05 to 80% by weight, very particularly preferably from 0.1 to 40% by weight, in particular from 0.5 to 15% by weight.

The content of said organosiloxanes in inventive water- and/or alcohol-containing compositions is advantageously from 0.005 to 40% by weight, preferably from 0.05 to 20% by weight, particularly preferably from 0.1 to 15% by weight, very particularly preferably from 0.5 to 10% by weight, in particular from 1.5 to 6% by weight.

Inventive compositions generally also feature from 0.001 to 99.9% by weight, preferably from 0.01 to 40% by weight, particularly preferably from 0.05 to 20% by weight, very particularly preferably from 0.1 to 15% by weight content of alcohol from the series methanol, ethanol, isopropanol, and a mixture composed of two of the abovementioned alcohols.

Inventive compositions may also comprise from 0.001 to 99.5% by weight, preferably from 1 to 80% by weight, particularly preferably from 5 to 70% by weight, very particularly preferably from 20 to 60% by weight, in particular from 30 to 55% by weight, content of water.

Inventive compositions moreover suitably comprise, based on the composition, from 0.001 to 5% by weight, preferably from 0.01 to 2% by weight, particularly preferably from 0.05 to 1% by weight, in particular from 0.1 to 0.6% by weight, of acid. HX acids of formulae II and IV are particularly preferred.

Inventive compositions therefore suitably have a pH of from 2 to 6, preferably from 2.5 to 4.5, particularly preferably from 3 to 4. The pH here may moreover be further stabilized via addition of a buffer.

Inventive compositions may moreover have from 0 to 10% by weight, preferably from 2 to 6% by weight, particularly preferably from 4 to 5% by weight, content of wetting auxiliaries. Wetting auxiliaries particularly preferred are butyl glycol and polyethersiloxanes, such as polyethertrisiloxanes, e.g. TEGOPREN® 5840 or Tego Wet 270 from Goldschmidt (Degussa AG).

Other preferred constituents in inventive compositions are from 0 to 20% by weight, particularly preferably from 1 to 15% by weight, in particular from 5 to 12% by weight, of inorganic or organic particles. The median particle size d₅₀ of these particles is advantageously from 5 nm to 1 μm, particularly preferably from 20 nm to 0.8 μm, very particularly preferably from 200 nm to 300 nm, and the respective components of the composition here give 100% by weight in total.

Particles selected here are preferably from the series Teflon®, Levasil®, Christol®, Aerosil®, i.e. a fumed silica, precipitated silica, aluminum or aluminum oxides, aluminum hydroxides, or oxide hydroxides, titanium or titanium oxides, zirconium or zirconium oxides, to mention just a few examples.

By way of example, therefore, use may be made of 3417N—N polytetrafluoroethylene (PTFE) dispersion from DuPont with 60% by weight content of PTFE particles and with an average particle size of 0.2 μm. Levasil® products provide another example and are colloidal silica soles in water whose solids content, by way of example, is 21% by weight, with an average particle size of 15 nm, the particles suitably having a specific surface area (BET) of about 200 m²/g.

Inventive compositions advantageously have a flashpoint of from 20 to 90° C., preferably from 25 to 60° C. By way of example, flashpoint may be determined to DIN 51 755.

The present invention also provides block condensates of the general formula [F]ₑ[Q_{c}P_{b}]_{d} (I) as claimed in claim 1.

Said block condensates generally feature good water solubility. Inventive compositions are therefore generally advantageously capable of dilution with water. However, other diluents that may be used are, by way of example, alcohols, such as methanol, ethanol, or isopropanol, to mention just a few diluents.

The present invention also provides inventive compositions or block condensates obtainable via reaction of block units F with block units Q, P, and/or QP, or with organosilane/organosiloxane mixtures which comprise at least one of the abovementioned hydrolyzable block units, by
c1) diluting block unit F optionally with an alcohol, adding an organic or inorganic acid and from 0.5 to 150 mol of water per mole of Si of the organosilane or siloxane used, whereupon at least partial hydrolysis of the block units used takes place, then adding block unit Q and block unit P, and allowing the mixture to react, the molar proportion of Si here and hereinafter always being calculated as Si of the organosilane or of the organosiloxane mixture of the corresponding block unit,
   or
c2) diluting block unit F optionally with an alcohol, mixing with Q, P, and/or block unit QP, then adding an organic or inorganic acid and, using from 0.5 to 150 mol of water per mole of Si of the siloxanes used, carrying out partial hydrolysis and block-condensation,
   or
c3) diluting block unit F optionally with an alcohol, adding an organic or inorganic acid and from 0.5 to 150 mol of water per mole of Si of the siloxane used, with at least partial hydrolysis, adding block unit QP, and allowing the mixture to react,
   or
c4) diluting block units Q, P, and/or QP, optionally with an alcohol, adding an organic or inorganic acid and from 0.5 to 1.5 mol of water per mole of Si of the siloxanes used, and at least partially hydrolyzing, then adding block unit F and also from 0 to 148.5 mol of water per mole of Si of the siloxanes used, and allowing the mixture to react,
   or
c5) diluting block unit F optionally with an alcohol, mixing with from 0.5 to 150 mol of water per mole of Si of the siloxanes used, and with an organic or inorganic acid, and then adding a tetraalkoxysiloxane, and allowing the mixture to react.

The quotient calculated here from the molar Si ratio F/Q is preferably from 0.1 to 8, particularly preferably from 0.3 to 5, in particular from 0.5 to 3, and the quotient calculated from Q/P is preferably from 0.5 to 10, particularly preferably from 0.8 to 4, in particular from 1 to 3, and reference is made here to the proportions or Si ratios of the block units F, Q, and P or QP given by e, c, b, and d in formula I.

The procedures described above may moreover use the block units F, Q, P, and PQ in a previously hydrolyzed form, thus then permitting the addition of acid and, respectively, water to be omitted.

The inventive reaction here is suitably carried out at a temperature of from 0 to 100° C., preferably from 20 to 70° C., particularly preferably at from 25 to 65° C.

In particular, the partial hydrolysis of block units in the present preparation process is carried out at a temperature of from 0 to 60° C., preferably from 20 to 55° C., particularly preferably from 40 to 50° C.

According to the invention, the block condensation is carried out at a preferred temperature of from 25 to 100° C., preferably from 40 to 70° C., particularly preferably from 50 to 65° C.

In the inventive preparation process it is moreover possible to add, based on the composition, from 0 to 10% by weight, preferably from 2 to 6% by weight, particularly preferably from 4 to 5% by weight, of at least one wetting auxiliary to the mixture composed of block units, or after the partial hydrolysis of the block units, or after the block condensation. This can advantageously affect the orientation of the fluoro-organofunctional groups in the active ingredient, in particular in terms of the application. Wetting auxiliaries particularly preferred are a polyethersiloxane or butyl glycol.

In another method of obtaining inventive compositions or block condensates, inorganic or organic particles are preferably added to the mixture of the block units, or after partial hydrolysis of the block units, or after block condensation, during the preparation process. A suitable method here uses, based on the composition, from 0 to 20% by weight, particularly preferably from 1 to 15% by weight, in particular from 5 to 10% by weight, of abovementioned nanoscale to microscale particles, generally using good and thorough mixing for this incorporation process.

Another method of obtaining inventive compositions or block condensates advantageously adds from 0.001 to 10 mol, preferably from 0.005 to 5 mol, particularly preferably from 0.01 to 1 mol, very particularly preferably from 0.05 to 0.5 mol, of tetraalkoxysilane, in particular tetraethoxysilane, per mole, calculated as Si, of the block condensate, to block units F, or to a mixture composed of block units F and P, Q, and/or PQ, or after the partial hydrolysis of said block units, or after the block condensation, and allowing the reaction to continue.

In the inventive process, the product of the block-condensation reaction may also be allowed to continue reacting for a period of from 5 minutes to 5 hours, preferably from 15 minutes to 2 hours, with stirring, at a temperature of from 25 to 65° C., preferably from 40 to 55° C., and this can generally give a substantially stabler condensation state of the block units at room temperature, even for periods extending to 2 months and longer.

In the present process it is also possible to remove some of the alcohol from the system, following the step of block-condensation or of continued reaction, for example via distillation at reduced pressure, suitably at a temperature of from 20 to 40° C. However, an alcohol and/or water may also be added to the inventive product of the block-condensation reaction.

The starting components for the preparation of an inventive composition or of inventive block condensates may advantageously be obtained as follows:

block units F are preferably obtainable by mixing
a1) at least one aminoalkylsilane of the general formula (V)

H₂N(CH₂)_{§}[(NH)_{$}(CH₂)_{&}]_{β}—Si(CH₃)ₜ(OR)₃₋ₜ (V),
where 0≦§≦6, 0≦&≦6, $=0 if §=0 then β=1, $=1 if §>0 then β=1 or 2, t=0 or 1, and R is a linear, cyclic, or branched alkyl group having from 1 to 4 carbon atoms,
   and at least one fluoroorganosilane of the general formula (VI)

R³—Y_{#}—(CH₂)₂—Si(R¹)ₘ(OR)₃₋ₘ (VI),
where R³ is a linear, cyclic, or branched mono-, oligo-, or polyfluorinated alkyl group having from 1 to 13 carbon atoms or a mono-, oligo-, or polyfluorinated aryl group, Y is a CH₂, O, or S group, where #=0 or 1, R¹ is a linear, cyclic, or branched alkyl group having from 1 to 8 carbon atoms, m=0 or 1, and R is a linear, cyclic, or branched alkyl group having from 1 to 4 carbon atoms,
   in a molar ratio of ≧0.29:1, particularly preferably from 0.3:1 to 2:1, in particular from 0.33:1 to 0.5:1, optionally adding an organic or inorganic acid, preferably hydrochloric acid, formic acid, or acetic acid, the desired degree of neutralization of the amino groups present here being in particular 100%, diluting optionally with at least one alcohol, preferably methanol, ethanol, or n-propanol or isopropanol and, with addition of from 0.5 to 150 mol of water per mole of Si of the silane components used, carrying out at least partial hydrolysis and cocondensation. Optionally, excess alcohol may then be removed from the system, and the pH may be adjusted to <11. This generally gives a mixture of cocondensates with random distribution, i.e. preferably one type of the block units given by F.

In another preferred method, block units F are obtainable by
a2) diluting at least one fluoroorganosilane of the general formula (VI)

R³—Y_{#}—(CH₂)₂—Si(R¹)ₘ(OR)₃₋ₘ (VI)
where R³ is a linear, cyclic, or branched mono-, oligo-, or polyfluorinated alkyl group having from 1 to 13 carbon atoms or a mono-, oligo-, or polyfluorinated aryl group, Y is a CH₂, O, or S group, where #=0 or 1, R¹ is a linear, cyclic, or branched alkyl group having from 1 to 8 carbon atoms, m=0 or 1, and R is a linear, cyclic, or branched alkyl group having from 1 to 4 carbon atoms,
   optionally with at least one alcohol, preferably methanol, ethanol, or n-propanol or isopropanol and, with addition of from 0.5 to 100 mol of water per mole of Si of the silane components used, and with addition of an organic or inorganic acid, preferably hydrochloric acid, formic acid, or acetic acid, in particular from 0.1 to 3 mol per mole of Si of the silanes used, carrying out at least partial hydrolysis and condensation.

In another preferred method, block units F are obtained by
a3) mixing at least one aminoalkylsilane of the general formula (V)

H₂N(CH₂)_{§}[(NH)_{$}(CH₂)_{&}]_{β}—Si(CH₃)ₜ(OR)₃₋ₜ (V),
where 0≦§≦6, 0≦&≦6, $=0 if §=0 then β=1, $=1 if §>0 then β=1 or 2, t=0 or 1, and R is a linear, cyclic, or branched alkyl group having from 1 to 4 carbon atoms,
   and at least one fluoroorganosilane of the general formula (VI)

R³—Y_{#}—(CH₂)₂—Si(R¹)ₘ(OR)₃₋ₘ (VI),
where R³ is a linear, cyclic, or branched mono-, oligo-, or polyfluorinated alkyl group having from 1 to 13 carbon atoms or a mono-, oligo-, or polyfluorinated aryl group, Y is a CH₂, O, or S group, where #=0 or 1, R¹ is a linear, cyclic, or branched alkyl group having from 1 to 8 carbon atoms, m=0 or 1, and R is a linear, cyclic, or branched alkyl group having from 1 to 4 carbon atoms,
   and at least one alkoxysilane of the general formula VII

(R²)ₖSi(OR)₄₋ₖ (VII),
where groups R² are identical or different and R² is a linear, cyclic or branched alkyl group having from 1 to 18 carbon atoms, k=0 or 1 or 2, and R is a linear, cyclic, or branched alkyl group having from 1 to 4 carbon atoms,
   are mixed in a molar ratio of ≧0.29:1, preferably from 0.3:1 to 4:1, where the molar ratio of fluoroorganosilane to alkoxysilane is preferably from 1:0 to 1:5, in particular from 1:0.001 to 1:1 adding from 0.12 to 1 mol of an organic or inorganic acid, preferably hydrochloric acid, formic acid, or acetic acid per mole of silane component to the silane mixture present, diluting optionally with at least one alcohol, preferably methanol, ethanol, or n-propanol or isopropanol and, with addition of from 0.5 to 150 mol of water per mole of Si of the silane components used, carrying out at least partial hydrolysis and cocondensation.

In another preferred method, block units Q, P, and/or QP are obtainable by
b1) diluting at least one tetraalkoxysilane with an alcohol and, with addition of from 0.5 to 30 mol of water per mole of alkoxysilane, carrying out hydrolysis and condensation, thus giving block units given by Q, or
b2) diluting at least one alkylalkoxysilane of the abovementioned formula VII, where k=1 or 2, with an alcohol and, with addition of from 0.5 to 30 mol of water per mole of alkoxysilane, carrying out hydrolysis and condensation, thus giving block units given by P, or
b3) to prepare block units QP, using at least one tetraalkoxysilane together with at least one alkylalkoxysilane of the general formula VII where k=1 or 2 in a molar ratio of from 0.5:1 to 10:1, diluting the mixture optionally with an alcohol and, with addition of acid and from 0.5 to 150 mol of water per mole of the silanes used carrying out hydrolysis and cocondensation,
   or
condensing tetraalkoxysilane onto block units P, by using as initial charge 1 mol of the block unit P, calculated as Si of the siloxane of the block unit P, diluting with an alcohol, adding from 0.5 to 10 mol of tetraalkoxysilane per mole of Si of the block unit P and, with addition of acid and from 0.5 to 150 mol of water, carrying out partial hydrolysis and condensation,
   or
condensing at least one alkylalkoxysilane onto block units Q, by using as initial charge from 0.5 to 10 mol of the block unit Q, calculated as Si of the siloxane of the block unit Q, diluting with an alcohol, adding 1 mol of at least one alkylalkoxysilane of the general formula VII and, with addition of acid and from 0.5 to 150 mol of water, carrying out partial hydrolysis and condensation,
   or
condensing block units P and Q, by using as initial charge block units P composed of b2) and Q composed of b1) with a molar ratio, in each case based on their Si content, of from 1:10 to 2:1 in the mixture, diluting optionally with an alcohol and, with addition of from 0.5 to 30 mol of water per mole of Si of the siloxane mixture present, carrying out hydrolysis and block-condensation.

The reactions given by b1) and b3) are suitably carried out at a temperature between room temperature and about 60° C., and those given by b2) are suitably carried out at from 0 to about 60° C., the hydrolysis time in b2) here generally being about 75% shorter than in b1). The pH here should always be from 1 to 5, preferably from 1.5 to 2.5.

The following fluoroorganosilanes of formula VI are preferably used for the preparation of said block units: F₃C(CF₂)₅(CH₂)₂—Si(OCH₃)₃, F₃C(CF₂)₅(CH₂)₂—Si(OC₂H₅)₃, F₃C(CF₂)₇(CH₂)₂—Si(OCH₃)₃, F₃C(CF₂)₇(CH₂)₂—Si(OC₂H₅)₃, F₃C(CF₂)₉(CH₂)₂—Si(OCH₃)₃, F₃C(CF₂)₉(CH₂)₂—Si(OC₂H₅)₃, F₃C(CF₂)₁₁(CH₂)₂—Si(OCH₃)₃, F₃C(CF₂)₁₁(CH₂)₂—Si(OC₂H₅)₃, HCF₂(CF₂)O(CH₂)₃Si(OCH₃)₃, HCF₂(CF₂)O(CH₂)₃Si(OC₂H₅)₃.

The aminoalkylsilane used of formula V moreover preferably comprises 3-aminopropyltrimethoxysilane, 3-aminopropyltriethoxysilane, 3-aminopropylmethyldiethoxysilane, N-(2-aminoethyl)-3-aminopropyltrimethoxysilane, alkoxysilanes having free triaminoalkyl functions, non-exclusive examples being H₂N(CH₂)₂NH(CH₂)₂NH(CH₂)₃—Si(OCH₃)₃, H₂N(CH₂)₂NH(CH₂)₂NH(CH₂)₃—Si(OC₂H₅)₃, [H₂N(CH₂)₂]₂N(CH₂)₃—Si(OCH₃)₃, [H₂N(CH₂)₂]₂N(CH₂)₃—Si(OC₂H₅)₃, in particular DYNASYLAN® TRIAMO, and mixtures composed of at least two aminoalkylsilanes.

Preference is also given to alkoxysilanes of the formula VII from the series tetramethoxysilane, tetraethoxysilane, tetra-n-propylsilane, methyltrimethoxysilane, methyltriethoxysilane, n-propyltrimethoxysilane, n-propyltriethoxysilane, isobutyl-trimethoxysilane, isobutyltriethoxysilane, n-octyltrimethoxysilane, isooctyltriethoxysilane, hexadecyltrimethoxysilane, hexadecyltriethoxysilane, octadecyltrimethoxysilane, and octadecyltriethoxysilane, to mention just a few alkoxysilanes.

Other preferred starting components for block units F in the present process are those given by the teaching of EP 1 101 787 A, EP 0 846 716 A, and EP 0 846 717 A and the entire scope of the contents of the abovementioned citations is hereby incorporated into the disclosure of the present patent application.

Other block units Q which may be used in the inventive preparation process comprise alkyl polysilicates, i.e. oligomeric silicic esters, in particular ethyl polysilicate, e.g. DYNASIL® 40, DYNASIL® MKS, or DYNASIL® GH2.

Block units P or QP incorporated into the disclosure of this present patent application moreover preferably comprise the cocondensates and, respectively, condensates given by EP 0 716 127 A, EP 1 205 505 A, EP 0 518 056 A, EP 0 814 110 A, EP 1 205 481 A, EP 0 675 128 A.

The present invention therefore also provides a process for the preparation of inventive compositions or of inventive block condensates, which comprises reacting block units F with block units Q, P, and/or QP, or reacting organosilanes/organosiloxane mixtures which contain at least one of the abovementioned hydrolyzable block units, by
c1) diluting block unit F optionally with an alcohol, adding an organic or inorganic acid and from 0.5 to 150 mol of water per mole of Si of the siloxane used, whereupon at least partial hydrolysis of the block units used takes place, then adding block unit Q and block unit P, and allowing the mixture to react,
   or
c2) diluting block unit F optionally with an alcohol, mixing with Q, P, and/or block unit QP, then adding an organic or inorganic acid and, using from 0.5 to 150 mol of water per mole of Si of the siloxanes used, carrying out partial hydrolysis and block-condensation,
   or
c3) diluting block unit F optionally with an alcohol, adding an organic or inorganic acid and from 0.5 to 150 mol of water per mole of Si of the siloxane used, with at least partial hydrolysis, adding block unit QP, and allowing the mixture to react,
   or
c4) diluting block units Q, P, and/or QP, optionally with an alcohol, adding an organic or inorganic acid and from 0.5 to 1.5 mol of water per mole of Si of the siloxanes used, and at least partially hydrolyzing, then adding block unit F and also from 0 to 148.5 mol of water per moleof Si of the siloxanes used,
   or
c5) diluting block unit F optionally with an alcohol, mixing with from 0.5 to 150 mol of water per mole of Si of the siloxanes used, and with an organic or inorganic acid, and then adding a tetraalkoxysilane, and allowing the mixture to react.

The following method is generally used to carry out the inventive process for the preparation of inventive block condensates or inventive compositions which comprise at least one inventive block condensate:

At least one type of block unit from the series Q or QP, P and, respectively, Q and P is generally used as initial charge. The mixture may also be diluted with a solvent, optionally with the corresponding alcohol. If the block units used here are not by this stage present in an at least partially hydrolyzed state, the block units used containing alkoxy groups should be at least partially hydrolyzed via controlled addition of acid and water, suitably with good and thorough mixing and temperature control. Block units F containing fluoroorgano groups and containing alkoxy or hydroxy groups, or an appropriate mixture comprising block units F, are then added, and block-condensation is carried out. The block-condensation, too, is generally carried out in a controlled manner with temperature control and optionally with addition of a wetting auxiliary. Monomeric tetraalkoxysilane may also be added during the block-condensation. At least some solvent or alcohol may also be removed from the product mixture.

However, another possible procedure for carrying out the inventive process uses as initial charge a mixture composed of the respective starting block units to be used, optionally dilutes and—where necessary—with addition of acid and water carries out controlled hydrolysis and block-condensation.

However, another method for carrying out the inventive reaction first carries out controlled pre-hydrolysis of the block units F and then carries out block-condensation using block units of type Q or QP and, respectively, Q and P.

In particular as given in version c5) of the process, it is also possible to omit any separate synthetic step for the preparation of the species Q, because tetraalkoxysilanes are highly reactive compounds in the presence of water or water and acid, and under these conditions hydrolyze very rapidly and condense, i.e. form block units Q. Tetraalkoxysilane can therefore be used directly for carrying out the block-condensation after block units F and, respectively, F, P and/or PQ, water, and optionally acid have been used as initial charge.

The value to which the pH of the respective reaction mixtures is generally controlled when carrying out hydrolysis, condensation, or block-condensation in versions of the present process is generally from 1 to 6, preferably from 1 to 4.

The versions described above of the process therefore generally give mixtures or compositions of inventive block condensates that are storage-stable for some months and which can be applied advantageously as they stand or after dilution with water and/or alcohol to a substrate, such as glass, ceramics, or concrete. Examples of application methods are application by polishing, spray-application, jet-application, doctor-application, brush-application, spreader-application, or application by immersion. The coating can then be allowed to dry and optionally subjected to subsequent heat treatment at from 60 to 300° C., i.e. stoved, for example.

The present invention also provides the advantageous use of an inventive block condensate or of an inventive composition which comprises at least one inventive block condensate, or of a block condensate or a composition obtainable from, or prepared by the inventive process, as an agent for easy-clean applications and/or corrosion-protection applications, or in agents for easy-clean applications and/or corrosion-protection applications, or in paints, inks, and lacquers.

The invention also provides the use of an inventive block condensate or of an inventive composition which comprises at least one block condensate, or said substances obtainable from or prepared by the inventive process, as starting material for the preparation of an agent, as claimed in claim 30, and here it is also possible for inventive compositions or block condensates to be mixed advantageously with other formulations, e.g. with lacquers.

The invention also provides a coating obtainable via use of an inventive block condensate, of an inventive composition, or of an inventive agent, where the inventive ingredient is applied as it stands, in the form of a composition, or in an agent, to a substrate surface, and is allowed to cure. This advantageously gives layer thicknesses of about 1-400 μm. The inventive coating features chemicals resistance, in particular with respect to dilute acids, alkaline solutions, and solvents, abrasion and weathering, and also resistance to boiling water. These coatings can also bring about a marked improvement in corrosion protection. They also feature excellent adhesion to surfaces in easy-clean applications, i.e. they have properties that repel oil, water, and soiling, in particular for protection from graffiti, i.e. in applications as anti-graffiti agent or anti-graffiti coating. Q-based coatings, in particular, feature excellent adhesion to the substrate and outstanding abrasion resistance.

The present invention therefore also provides items whose surface has been coated with a coating as claimed in claim 32, e.g. those with an inventive coating on a smooth or porous substrate surface, in particular metals, aluminum, aluminum alloys, copper, copper alloys, iron, iron alloys, in particular steel, steel armouring, glass, in particular plate glass, glass facades, windshields, and also concrete, e.g. reinforced concrete, concrete components, facades, masonry, sandstone, calcium silicate brick, ceramics, such as fired bricks, roof tiles, wall tiles, glazes, stone, such as marble, slate, granite, and also synthetic stone, synthetic materials, such as polymers, e.g. polyurethane, polycarbonate, and also natural materials, such as wood and cellulose. Preferred methods of applying the coating to the substrate surface which has previously been suitably cleaned are polishing, spray-application, jet-application, doctor-application, brush-application, spreader-application, or application by immersion, generally followed by brief drying.

The examples below provide further illustration of the present invention but do not restrict its subject-matter.

### EXAMPLES

### Inventive Example 1

50 g of ethanol, 21.6 g of DYNASIL® A (tetraethyl orthosilicate), and 2.0 g of formic acid (85% strength) were used as initial charge in a 1 l mixer with magnetic stirrer. 178.8 g of water were metered in within a period of about 10 minutes at from 50 to 56° C., with stirring. After 1.5 hours, 14.4 g of MTES (methyltrimethoxysilane) were added, and the mixture was stirred at about 65° C. for 45 minutes. 133.2 g of DYNASYLAN® F 8815 (a water-based organosiloxane containing fluoroalkyl/aminoalkyl/alkoxy and hydroxy groups with a molar ratio of the groups R^{f}:R^{a} of 3:1) were then added, and the mixture was stirred at from 58 to 64° C. for 15 minutes. This gave a clear to slightly opaque solution which was stable for more than two months.

### Inventive Example 2

Formulation as Example 1, to which 1.7 g of DUPONT 3417B-N Teflon dispersion, a 60% strength aqueous dispersion, 0.2 μm PTFE particles, basic, comprising surfactant, were added dropwise, with stirring gentle, and stirring was then continued for from 5 to 10 minutes. This gave a slightly cloudy solution.

### Inventive Example 3

105.6 g of ethanol, 14.4 g of DYNASIL® A (tetraethyl orthosilicate), and 4.0 g of formic acid (85% strength) were used as initial charge in a 1 l mixer with magnetic stirrer. 400.0 g of water were metered in within a period of about 10 minutes at from 42 to 50° C., with stirring. After 1.5 hours, 9.6 g of MTES (methyltrimethoxysilane) were added, and the mixture was stirred at about 65° C. for 45 minutes. 266.4 g of DYNASYLAN® F 8815 were then added, and the mixture was stirred at from 58 to 64° C. for 15 minutes. This gave a clear to slightly opaque solution which was stable for more than two months.

### Inventive Example 4

10% by weight of DYNASYLAN® F 8800 (an alcohol-based organosiloxane containing fluoroalkyl/aminoalkyl/alkoxy groups and hydroxy groups with a molar ratio of the groups R^{f}:R^{a} of 1:2) were mixed in 86.5% by weight of water and 0.5% by weight of 37% strength hydrochloric acid, and 1.8% by weight of tetraethyl orthosilicate (DYNASIL® A) were then added, with stirring, and stirring of the mixture was continued for 15 minutes. This was followed by slow metering-in of 1.2% by weight of MTES and about 2 hours of stirring at room temperature. The resultant solution was initially clear, then becoming opalescent to colloidal. The solution was stable in this form for about 1 year without sedimentation.

### Comparative Example A

10% by weight of DYNASYLAN® F 8800 were mixed in water with 0.5% by weight of 37% strength hydrochloric acid. The mixture was then stirred at room temperature for 2 hours, i.e. by analogy with EP 0 960 921 A. The solution was clear to slightly colloidal. The coatings given by this formulation on glass had only comparatively low abrasion resistance, cf. Table 1.

### Inventive Example 5

10 g of DYNASYLAN® F 8800 were used as initial charge in 85.5 g of water, and 1 g of 37% strength hydrochloric acid was admixed, and then 1.8 g of tetraethyl orthosilicate (DYNASIL® A) was added, with stirring, and stirring of the mixture was continued for 15 minutes.

### Inventive Example 6

204 g of water and 2 g of formic acid (85% strength) were used as initial charge in a 1 l mixer with magnetic stirrer. 21.6 g of DYNASIL® A were metered in within a period of about 20 minutes at from 32 to 56° C., with stirring. After 1 hour, 14.5 g of MTES were metered in rapidly and the mixture was stirred at about 60° C. for half an hour. 133 g of DYNASYLAN® F 8815, were then added, and stirring of the mixture was continued for 1.5 hours. 24 g of Levasil® (200 nm particles) were then added and the mixture was stirred for 20 minutes. The formulation was allowed to cool during that process. The resultant solution should be filtered through a corrugated filter prior to application of this formulation. The solution obtained was slightly cloudy.

### Inventive Example 7

The solution was prepared by analogy with Example 6, but 5% by weight of butyl glycol were also added to the formulation here. This achieved still better orientation of the fluoroalkyl groups on the subsequent substrate, via retarded crosslinking.

### Inventive Example 8

### Examples of Application of the Agents from Inventive Examples 1 to 6 and from Comparative Example A

Formulations described above were applied to test specimens composed of glass. The size of the glass plates was 0.15 m×0.15 m. The test specimens had previously been freed in a known manner from dust and grease.

The formulations were applied in the form of a liquid film, using a 35 μm doctor, and smoothed three times. The average layer thickness produced was about 1<400 μm. The average consumption of the coating solution during the application process was 22.3 g/m².

After the coating process, the glass plates were cured at room temperature for 3 days.

### Performance Tests on the Coatings

The following performance tests were carried out in order to assess the coatings, cf. Table 1:
1. The abrasion test served for assessment of the chemical bonding of the “easy-clean” coatings to smooth inorganic surfaces.
   The test equipment used comprised an abrasion tester from GARDNER, 250 ml glass beaker with stirrer bar, magnetic stirrer, and balance.
   The abrasion test [modified Erichsen test (DIN 53 778, Part 2), in which the brushes were replaced by an abrasive sponge] was carried out with a Glitzi abrasive sponge and a weight of 1 kg applied to an area of 7.5 cm×10.4 cm. The sliding of the mechanical system here was parallel to the substrate. One reciprocal movement is termed a cycle. Deionized water was used as lubricant.
   Prior to the start of the abrasion test, the angle of contact of the freshly coated glass plates with water was first measured (“untreated”). After every 5 000 cycles, the hydrophobic properties of the coating were determined by measuring contact angle. Care had to be taken to ensure that sufficient water was always present on the surfaces during the abrasion test.
   The contact angle with water was determined (DIN 828) using Krüss G10 contact-angle measurement equipment, via 6 individual measurements at various sites on the surface. The average (measured value) was calculated from the individual values. The term easy-clean properties ceases to apply when the contact angle is <80°.
2. Cross-cut hardness:
   The method of DIN EN ISO 2409 was used to determine and evaluate the hardness of a coating.

TABLE 1
Results of performance tests on the coating materials from Inventive
examples 1 to 6, Comparative example A, and a blind specimen:

| | | “Untreated” | “Abraded” | |
|---|---|---|---|---|
| Formulation | | contact angle | contact angle | Cross-cut |
| of example | Substrate | [degrees] | [degrees] | hardness |
| 1 | Glass | 111 | 100 | 2HS |
| 2 | Glass | 108 | 100 | — |
| 3 | Glass | 112 | 104 | — |
| 3 | Wood | 136 | — | — |
| | (particle | | | |
| | board) | | | |
| 3 | Polyurethane | 113 | — | — |
| 3 | Leather | 117 | — | — |
| 3 | Aluminum | 90 | — | — |
| A | Glass | 106 | 58 | — |
| 4 | Glass | 101 | 90 | — |
| 5 | Glass | 97 | 86 | — |
| 6 | Glass | 91 | 90 | 9HS |
| Uncoated blind | Glass | 15 | 15 | — |
| specimen | | | | |

Table 1 shows that the contact angle of untreated plate glass is about 15 degrees. In contrast, the untreated coatings on the substrates have a contact angle of from 90 to 136 degrees. After the grinding procedure has been carried out (“abraded”), the contact angles are smaller than in the untreated state. However, for Inventive examples 1-5 a reduction of only about 10% was seen, contrasting with about 40% for Comparative example A. Inventive easy-clean coatings therefore feature markedly improved abrasion resistance when compared with comparable prior art.

### Inventive Example 9

### a) Preparation of a Water-Soluble Block Condensate from: Aminoalkyltrialkoxysilane, Fluoroalkyltrialkoxysilane, Tetraalkoxysilane, and Alkyltrialkoxysilane

### Preparation of Block Unit 1 (Cocondensate Composed of Aminosilane and Fluorosilane):

77.8 g of aminopropyltriethoxysilane and 412.5 g of DYNASYLAN® F 8261 were mixed and temperature-controlled to about 60° C. 20.9 g of water were then metered in within a period of 5 minutes. The hydrolysis and cocondensation were continued at reflux for 5 hours at about 80° C. 20.9 g of formic acid (85% by weight in water) were then metered in within a period of about 10 minutes at about 50° C. Temperature control of the mixture at about 80° C. was continued for about 4 hours.

### Preparation of Block Unit 2 (Cocondensate Composed of Tetraalkoxysilane and Alkyltrialkoxysilane):

7.4 g of formic acid and 1 351.5 g of water were used as initial charge. A mixture composed of 82.5 g of tetraethoxysilane and 27.5 g of methyltriethoxysilane was added within a period of 1 minute, at about 40° C. The mixture was heated to about 75° C., and slight reflux occurred. The hydrolysis and cocondensation of the silane units was continued for a further 6 hours at about 75° C.

After cooling of the block unit 2 to 35° C., block unit 1 was added within a period of two minutes. This gave a milky mixture. The mixture was then heated to about 50° C., and the hydrolysis alcohols were removed at a pressure of from 150 to 120 mbar by way of a distillation bridge. The amount of distillate removed during the distillation was replaced by 4 portions of water, the amount being 136.3 g, so that the weight of the reaction vessel contents remained almost constant. The distillation had been completed within a period of 7 hours. The liquid still present in the reaction vessel was opaque and storage-stable for some months. It can be used as an impregnating material with properties that repel water, oil, soiling, and paint and ink, for example for porous, mineral construction materials.

### b) Use of the Material of a)

The product from a) was spray-applied to the smooth molded side of a concrete test specimen, using HVLP equipment with consumption rate of about 100 g/m², with about ½ hour of drying at room temperature (about 20° C., about 50% relative humidity). The product from a) was then again spray-applied to this pre-treated concrete surface, using an HVLP spray gun with consumption rate of about 20 g/m². The concrete panel had by this stage developed hydrophobic properties, and the fine droplets formed were therefore spread with a brush to give a homogeneous film of liquid. After drying (½ hour, 20° C., 50% relative humidity), another 20 g/m² of product from a) were applied to the concrete panel, using the HVLP process. Again, the fine droplets formed were spread with a soft brush to give a homogeneous film of liquid. The concrete surface was assessed after drying and curing (16 hours, 60° C.), and anti-graffiti properties were assessed. The color had become darker, only slightly, but visibly. The surface was smooth and non-tacky. A felt-tip pen mark (Edding 3000) applied could be removed from the surface with ethanol, leaving no residue. The appearance and feel of the treated substrate were entirely satisfactory, and it had anti-graffiti properties.

### c) Comparative Example

### Use of a Cocondensate of the Prior Art

The product from Example 1 of EP 1 101 787 A1 was spray-applied to the smooth molded side of a concrete test specimen, using HVLP equipment with consumption rate of about 100 g/m², with about ½ hour of drying at room temperature (about 20° C., about 50% relative humidity). The product was then again spray-applied to this pre-treated concrete surface, using an HVLP spray gun with consumption rate about 20 g/m². The concrete panel had by this stage developed hydrophobic properties, and the fine droplets formed were therefore spread with a brush to give a homogeneous film of liquid. After drying (½ hour, 20° C., 50% relative humidity), about another 20 g/m² of product were applied to the concrete panel, using the HVLP process. Again, the fine droplets formed were spread with a soft brush to give a homogeneous film of liquid. The concrete surface was assessed after drying and curing (16 hours, 60° C.). The darkening of color was clearly visible. The surface was smooth but tacky. There was therefore a risk that soiling particles would accumulate on the tacky surface. A felt-tip pen mark (Edding 3000) applied could be removed from the surface with ethanol, leaving no residue. The appearance and feel of the treated substrate were not ideal, but anti-graffiti properties were entirely satisfactory.

1-33. (canceled)

34. A block condensate of the general formula I
[F]ₑ[Q_{c}P_{b}]_{d} (I)
wherein
e, c and d are identical or different, and each may be a number from 1 to 10, and b may be a number from 0 to 10,
F is a linear, cyclic, branched, or crosslinked cocondensate unit from the series of fluororgano-/aminoalkyl-/alkyl-/alkoxy- or hydroxysiloxanes of the general formula II
R[—O—Si(OR)₂]_{w}[—O—Si(R^{f})(R¹)₁₋ₕ(OR)ₕ]ₓ[—O—Si{R^{a}(HX)_{g}}(CH₃)₁₋ᵢ(OR)ᵢ]_{y}[—O—Si(R²)₂₋ⱼ(OR)ⱼ]_{z}(OR) (II),
where R^{f} is a mono-, oligo- or polyfluorinated organoalkyl or organoaryl group of the formula (IIa) R³—Y_{#}—(CH₂)₂—, where R³ is a linear, cyclic, or branched mono-, oligo-, or polyfluorinated alkyl group having from 1 to 13 carbon atoms or a mono-, oligo-, or polyfluorinated aryl group, Y is a CH₂, O, or S group, where #=0 or 1,
R^{a} is an aminoalkyl group of the general formula (IIb) H₂N(CH₂)_{§}[(NH)_{$}(CH₂)_{&}]_{β}—, where 0≦§≦6, 0≦&≦6, $=0 if §=0 then B=1, $=1 if §>0 then β=1 or 2, and X is an acid radical from the series chloride, formate, and acetate where g=0 or 1 or 2 or 3,
h, l, and j, independently of one another, are 0 or 1,
groups R² are identical or different, and R² is a linear, cyclic, or branched alkyl group having from 1 to 18 carbon atoms,
R¹ is a linear, cyclic, or branched alkyl group having from 1 to 8 carbon atoms,
groups R are identical or different and are a hydrogen atom or a linear, cyclic, or branched alkyl group having from 1 to 4 carbon atoms, or RO is an —O—Si— bond to at least one unit from the series F, Q or P,
x, y, z and w are identical or different, and x, and also y, is a number >0, and z, and also w, is a number ≧0, where (x+y+z+w)≧2,
Q is an alkyl silicate unit of the general formula III
(RO)ₙSiO_{(4-n)/2} (III),
where groups R are identical or different and are a hydrogen atom or a linear, cyclic, or branched alkyl group having from 1 to 4 carbon atoms, or RO are an —O—Si— bond to at least one unit from the series F, Q, or P, and n=1 or 2 or 3,
and
P is a linear, cyclic, branched, or crosslinked condensate unit or, respectively, cocondensate unit of the general formula IV
R[—O—Si(R²)₂₋ᵥ(OR)ᵥ]ᵣ[—O—Si{R^{a}(HX)_{g}}(CH₃)₁₋ᵤ(OR)ᵤ]ₛ(OR) (IV),
where R^{a} is an aminoalkyl group of the general formula (IVa) H₂N(CH₂)_{§}[H)_{$}(CH₂)_{&}]_{β}—, where 0≦§≦6, 0≦&≦6, $=0 if §=0 then β=1, $=1 if §>0 then β=1 or 2, and X is an acid radical from the series chloride, formate, and acetate where g=0 or 1 or 2 or 3,
groups R² are identical or different, and R² is a linear, cyclic, or branched alkyl group having from 1 to 18 carbon atoms,
v=0 or 1 or 2, and u is 0 or 1,
groups R are identical or different and are a hydrogen atom or a linear, cyclic, or branched alkyl group having from 1 to 4 carbon atoms, or RO is an —O—Si— bond to at least one unit from the series F, Q or P,
r and s are identical or different, and r≧0, s≧0, where (r+s)≧1.

35. The block condensate as claimed in claim 34, which is water-soluble.

36. The block condensate as claimed in claim 34, obtainable via reaction of block units F with block units Q, P, and/or QP, by
c1) diluting block unit F optionally with an alcohol, adding an organic or inorganic acid and from 0.5 to 150 mol of water per mole of Si of the siloxane used, whereupon at least partial hydrolysis of the block units used takes place, then adding block unit Q and block unit P, and allowing the mixture to react,
or
c2) diluting block unit F optionally with an alcohol, mixing with Q, P, and/or block unit QP, then adding an organic or inorganic acid and, using from 0.5 to 150 mol of water per mole of Si of the siloxanes used, carrying out partial hydrolysis and block-condensation,
or
c3) diluting block unit F optionally with an alcohol, adding an organic or inorganic acid and from 0.5 to 150 mol of water per mole of Si of the siloxane used, with at least partial hydrolysis, adding block unit QP, and allowing the mixture to react,
or
c4) diluting block units Q, P, and/or QP, optionally with an alcohol, adding an organic or inorganic acid and from 0.5 to 1.5 mol of water per mole of Si of the siloxanes used, and at least partially hydrolyzing, then adding block unit F and also from 0 to 148.5 mol of water per mole of Si of the siloxanes used, and allowing the mixture to react,
or
c5) diluting block unit F optionally with an alcohol, mixing with from 0.5 to 150 mol of water per mole of Si of the siloxanes used, and with an organic or inorganic acid, and then adding a tetraalkoxysiloxane, and allowing the mixture to react.

37. The block condensate obtainable as claimed in claim 36,
wherein
the reaction is carried out at a temperature of from 0 to 100° C.

38. The block condensate obtainable as claimed in claim 36,
wherein
the partial hydrolysis of block units is carried out at a temperature of from 0 to 60° C.

39. The block condensate obtainable as claimed in claim 36,
wherein
the block-condensation is carried out at a temperature of from 25 to 100° C.

40. The block condensate obtainable as claimed in claim 36,
wherein
at least one wetting auxiliary is added to the mixture composed of block units, or after the partial hydrolysis of the block units, or after the block-condensation.

41. The block condensate obtainable as claimed in claim 40,
wherein
a polyethersiloxane or butyl glycol is added as wetting auxiliary.

42. The block condensate obtainable as claimed in 36,
wherein
inorganic or organic particles are added to the mixture composed of block units, or after the partial hydrolysis of the block units, or after the block-condensation.

43. The block condensate obtainable as claimed in claim 36,
wherein
from 0.001 to 10 mol of tetraalkoxysilane per mole, calculated as Si, of the block condensate is added to block units F or to a mixture composed of block units F and P, Q, and/or PQ, or after the partial hydrolysis of said block units, or after the block-condensation, and reaction is allowed to continue.

44. The block condensate obtainable as claimed in claim 36,
wherein
the product of the block-condensation reaction is permitted to continue reaction for a period of from 5 minutes to 5 hours at a temperature of from 25 to 65° C., with stirring.

45. The block condensate obtainable as claimed in claim 36,
wherein
at least some alcohol is removed from the system following the block-condensation step or the continued-reaction step.

46. The block condensate obtainable as claimed in claim 36, where use is made of block units F obtained by mixing
a1) at least one aminoalkylsilane of the general formula (V)
H₂N(CH₂)_{§}[(NH)_{$}(CH₂)_{&}]_{β}—Si(CH₃)ₜ(OR)₃₋ₜ (V),
where 0≦§≦6, 0≦&≦6, $=0 if §=0 then β=1, $=1 if §>0 then β=1 or 2, t=0 or 1, and R is a linear, cyclic, or branched alkyl group having from 1 to 4 carbon atoms,
and at least one fluoroorganosilane of the general formula (VI)
R³—Y_{#}—(CH₂)₂—Si(R¹)ₘ(OR)₃₋ₘ (VI),
where R³ is a linear, cyclic, or branched mono-, oligo-, or polyfluorinated alkyl group having from 1 to 13 carbon atoms or a mono-, oligo-, or polyfluorinated aryl group, Y is a CH₂, O, or S group, where #=0 or 1, R¹ is a linear, cyclic, or branched alkyl group having from 1 to 8 carbon atoms, m=0 or 1, and R is a linear, cyclic, or branched alkyl group having from 1 to 4 carbon atoms,
in a molar ratio of ≧0.29:1, optionally adding at least one organic or inorganic acid, diluting optionally with at least one alcohol and, with addition of from 0.5 to 150 mol of water per mole of Si of the silane components used, carrying out at least partial hydrolysis and cocondensation, or
a2) diluting at least one fluoroorganosilane of the general formula (VI)
R³—Y_{#}—(CH₂)₂—Si(R¹)ₘ(OR)₃₋ₘ (VI)
where R³ is a linear, cyclic, or branched mono-, oligo-, or polyfluorinated alkyl group having from 1 to 13 carbon atoms or a mono-, oligo-, or polyfluorinated aryl group, Y is a CH₂, O, or S group, where #=0 or 1, R¹ is a linear, cyclic, or branched alkyl group having from 1 to 8 carbon atoms, m=0 or 1, and R is a linear, cyclic, or branched alkyl group having from 1 to 4 carbon atoms,
optionally with at least one alcohol and, with addition of from 0.5 to 150 mol of water per mole of Si of the silane components used, and with addition of an organic or inorganic acid, carrying out at least partial hydrolysis and condensation, or
a3) mixing at least one aminoalkylsilane of the general formula (V)
H₂N(CH₂)_{§}[(NH)_{$}(CH₂)_{&}]_{β}—Si(CH₃)ₜ(OR)₃₋ₜ (V),
where 0≦§≦6, 0≦&≦6, $=0 if §=0 then β=1, $=1 if §>0 then β=1 or 2, t=0 or 1, and R is a linear, cyclic, or branched alkyl group having from 1 to 4 carbon atoms,
and at least one fluoroorganosilane of the general formula (VI)
R³—Y_{#}—(CH₂)₂—Si(R¹)ₘ(OR)₃₋ₘ (VI),
where R³ is a linear, cyclic, or branched mono-, oligo-, or polyfluorinated alkyl group having from 1 to 13 carbon atoms or a mono-, oligo-, or polyfluorinated aryl group, Y is a CH₂, O, or S group, where #=0 or 1, R¹ is a linear, cyclic, or branched alkyl group having from 1 to 8 carbon atoms, m=0 or 1, and R is a linear, cyclic, or branched alkyl group having from 1 to 4 carbon atoms,
and at least one alkoxysilane of the general formula VII
(R²)ₖSi(OR)₄₋ₖ (VII),
where groups R² are identical or different and R² is a linear, cyclic or branched alkyl group having from 1 to 18 carbon atoms, k=0 or 1 or 2, and R is a linear, cyclic, or branched alkyl group having from 1 to 4 carbon atoms,
are mixed in a molar ratio of ≧0.29:1 for aminoalkylsilane: total of fluoroorganosilane and alkoxysilane, adding from 0.12 to 1 mol of an organic or inorganic acid per mole of silane component to the silane mixture present, diluting optionally with at least one alcohol and, with addition of from 0.5 to 150 mol of water per mole of Si of the silane components used, carrying out at least partial hydrolysis and cocondensation.

47. The block condensate obtainable as claimed in claim 36, where use is made of block units Q, P, and/or QP obtainable by
b1) diluting at least one tetraalkoxysilane with an alcohol and, with addition of from 0.5 to 30 mol of water per mole of alkoxysilane, carrying out hydrolysis and condensation, or
b2) diluting at least one alkylalkoxysilane of the abovementioned formula VII, where k=1 or 2, with an alcohol and, with addition of from 0.5 to 30 mol of water per mole of alkoxysilane, carrying out hydrolysis and condensation, or
b3) to prepare block units QP, using at least one tetraalkoxysilane together with at least one alkylalkoxysilane of the general formula VII where k=1 or 2 in a molar ratio of from 0.5:1 to 10:1, diluting the mixture optionally with an alcohol and, with addition of acid and from 0.5 to 150 mol of water per mole of the silanes used carrying out hydrolysis and cocondensation,
or
condensing tetraalkoxysilane onto block units P, by using as initial charge 1 mol of the block unit P, calculated as Si of the siloxane of the block unit P, diluting with an alcohol, adding from 0.5 to 10 mol of tetraalkoxysilane per mole of Si of the block unit P and, with addition of acid and from 0.5 to 150 mol of water, carrying out partial hydrolysis and condensation,
or
condensing at least one alkylalkoxysilane onto block units Q, by using as initial charge from 0.5 to 10 mol of the block unit Q, calculated as Si of the siloxane of the block unit Q, diluting with an alcohol, adding 1 mol of at least one alkylalkoxysilane of the general formula VII and, with addition of acid and from 0.5 to 150 mol of water, carrying out partial hydrolysis and condensation,
or
condensing block units P and Q, by using as initial charge block units P composed of b2) and Q composed of b1) with a molar ratio, in each case based on their Si content, of from 1:10 to 2:1 in the mixture, diluting optionally with an alcohol and, with addition of from 0.5 to 30 mol of water per mole of Si of the siloxane mixture present, carrying out hydrolysis and block-condensation.

48. A composition which comprises
(i) at least one block condensate of organofunctional siloxanes of the general formula I
[F]ₑ[Q_{c}P_{b}]_{d} (I)
as claimed in claim 34 and/or
(ii) at least one mixture composed of e[F] and d(c[Q]+b[P]) and, where appropriate d[Q_{c}P_{b}],
where in each case independently of one another in the abovementioned features (i) and (ii)
the block units F, Q, P and/or QP may have linkage to one another by way of at least one Si—O—Si bond.

49. The composition as claimed in claim 48,
which has
from 0.001 to 99.9% by weight content of organosiloxanes.

50. The composition as claimed in claim 48,
which has
some content of alcohol from the series methanol, ethanol, isopropanol, butanol, and a mixture composed of at least two of the abovementioned alcohols.

51. The composition as claimed in claim 48,
which has
from 0.001 to 99.9% by weight content of alcohol.

52. The composition as claimed in claim 48,
which has
from 0.001 to 99.5% by weight content of water.

53. The composition as claimed in claim 48,
which has
based on the composition, from 0.001 to 5% by weight content of acid.

54. The composition as claimed in claim 48,
which has
a pH of from 1 to 6.

55. The composition as claimed in claim 48,
which has
from 0.001 to 99.5% by weight content of water and/or of substantially water-soluble solvents.

56. The composition as claimed in claim 48,
which has
from 0 to 10% by weight content of wetting auxiliaries.

57. The composition as claimed in claim 48,
which has
from 0 to 20% by weight content of inorganic or organic particles.

58. The composition as claimed in claim 48,
which has
a flashpoint of from 20 to 105° C.

59. The composition as claimed in claim 48,
which
is water-thinnable.

60. The composition as claimed in claim 48,
which
has liquid, treacly, or creamy consistency.

61. A process for the preparation of compositions as claimed in claim 48,
which comprises;
reacting block units F with block units Q, P, and/or QP, by
c1) diluting block unit F optionally with an alcohol, adding an organic or inorganic acid and from 0.5 to 150 mol of water per mole of Si of the siloxane used, whereupon at least partial hydrolysis of the block units used takes place, then adding block unit Q and block unit P, and allowing the mixture to react,
or
c2) diluting block unit F optionally with an alcohol, mixing with Q, P, and/or block unit QP, then adding an organic or inorganic acid and, using from 0.5 to 150 mol of water per mole of Si of the siloxanes used, carrying out partial hydrolysis and block-condensation,
or
c3) diluting block unit F optionally with an alcohol, adding an organic or inorganic acid and from 0.5 to 150 mol of water per mole of Si of the siloxane used, with at least partial hydrolysis, adding block unit QP, and allowing the mixture to react,
or
c4) diluting block units Q, P, and/or QP, optionally with an alcohol, adding an organic or inorganic acid and from 0.5 to 1.5 mol of water per mole of Si of the siloxanes used, and at least partially hydrolyzing, then adding block unit F and also from 0 to 148.5 mol of water per mole of Si of the siloxanes used, and allowing the mixture to react,
or
c5) diluting block unit F optionally with an alcohol, mixing with from 0.5 to 150 mol of water per mole of Si of the siloxanes used, and with an organic or inorganic acid, and then adding a tetraalkoxysilane, and allowing the mixture to react.

62. An agent comprising at least one composition prepared as claimed in claim 61, wherein the agent is prepared for at least one application selected from the group consisting of an easy-clean application, a corrosion-protection application, a combination of easy-clean and corrosion-protection application, a paints, an ink, and a lacquer.

63. A process for preparing an agent comprising:
including at least one of the compositions as prepared in claim 61 in a mixture; wherein the agent is for the purpose of at least one selected from the group consisting of an easy clean application, a corrosion-protection application, a combination of easy clean and corrosion-protection application, a paint, an ink and a lacquer.

64. A method comprising:
applying at least one composition prepared as claimed in claim 61 or an agent which comprises the composition to a substrate surface; and
curing the composition or agent applied to the substrate surface to produce a coating on the substrate surface with high abrasion resistance.

65. The coating obtained via the method as claimed in claim 64.

66. An item whose surfaces have been coated with the coating as claimed in claim 65.
